(19) United States
(12) Patent Application Publication
(10) Pub. No.: US 2024/0424409 A1
(43) Pub. Date: Dec. 26, 2024

(54) Method for Controlling Virtual Objects in Virtual Environment, Medium, and Electronic Device

(71) Applicant: Shanghai Lilith Technology Corporation, Shanghai (CN)

(72) Inventors: Huanhua Liao, Shanghai (CN); Junfeng Li, Shanghai (CN); Haonan Zhao, Shanghai (CN); Zhikai Li, Shanghai (CN); Xin Xiong, Shanghai (CN)

(21) Appl. No.: 18/698,668

(22) PCT Filed: Jun. 28, 2022
(86) PCT No.: PCT/CN2022/101797

§ 371 Date: Apr. 4, 2024

(51) Int. Cl. A63F 13/69; A63F 13/46; A63F 13/55

(52) U.S. Cl. CPC A63F 13/69; A63F 13/46; A63F 13/55

(57) ABSTRACT

The present disclosure discloses a method for controlling virtual objects in a virtual environment. The method includes: obtaining historical data of multiple historical plays of one or more first virtual objects, and setting corresponding style labels for respective first virtual objects; using the historical data of one or more first virtual objects belonging to respective style labels for training to obtain the second virtual objects; calculating experience scores of respective historical plays by using the historical data of respective historical plays; and determining matching labels corresponding to respective style labels by using the experience scores of respective historical plays of one or more first virtual objects belonging to respective style labels, and selecting one or more corresponding second virtual objects based on the matching labels to join to a current play. A problem that the AI companion has a single style and cannot match players with different gameplays is solved.

### TECHNICAL FIELD

The present disclosure relates to a field of data processing, and in particular, to a method for controlling virtual objects in a virtual environment, a medium, an electronic device, and a computer program product.

### BACKGROUND

AI (artificial intelligence) companions realized by using artificial intelligence technologies can improve game experiences of players through higher anthropomorphism and differentiated behavior styles. However, currently, the AI companion has a single style (that is, a strategy), cannot be adapted to players with different gameplays (for example, players like to head-to-head assault or develop in wild areas in FPS games), and strength (that is, ability) of the AI companion cannot be accordingly adjusted according to a game skill level owned by the player. For the player, if the AI companion is too strong or too weak, the game experience is reduced. Therefore, for different players, the AI companions are required to be personalized in two aspects of style and strength of the AI companion, and appropriate AI companions are selected for the players with different styles and different skill levels, so as to improve playing experiences of the players as much as possible. In addition, it is also hoped that the style of AI companion can be adjusted in real time during the game process.

### SUMMARY

Embodiments of the present disclosure provide a method for controlling a virtual object in a virtual environment, a medium, an electronic device, and a computer program product.

According to a first aspect, an embodiment of the present disclosure provides a method for controlling virtual objects in a virtual environment, used for an electronic device, the virtual objects comprises a first virtual object controlled by a user and a second virtual object controlled by artificial intelligence, wherein the method comprising:
a first obtaining step for obtaining historical data of multiple historical plays of one or more first virtual objects in the virtual environment, and setting corresponding style labels for respective first virtual objects based on the historical data;
a first training step for using the historical data of one or more first virtual objects belonging to respective style labels for training to obtain the second virtual objects corresponding to respective style labels;
a calculation step for calculating, for respective historical plays of each first virtual object, experience scores of respective historical plays by using the historical data of respective historical plays; and
a matching step for determining matching labels corresponding to respective style labels by using the experience scores of respective historical plays of one or more first virtual objects belonging to respective style labels, and selecting one or more corresponding second virtual objects based on the matching labels to join to a current play.

In a possible implementation of the first aspect, the multiple historical plays comprise a first type of historical play and a second type of historical play, and the current play comprises a first type of current play and a second type of current play,

wherein, in the matching step, determining first matching labels corresponding to respective style labels by using the experience scores of respective first type of historical plays of one or more first virtual objects belonging to respective style labels, and selecting one or more corresponding second virtual objects based on the first matching labels to join the first type of current play, and
determining second matching labels corresponding to respective style labels by using the experience scores of respective second type of historical plays of one or more first virtual objects belonging to respective style labels, and selecting one or more corresponding second virtual objects based on the second matching labels to join the second type of current play.

In a possible implementation of the first aspect, the determining first matching labels corresponding to respective style labels by using the experience scores of respective first type of historical plays of one or more first virtual objects belonging to respective style labels comprises:
obtaining a first highest experience score among the experience scores of the first type of historical plays of one or more first virtual objects belonging to respective style labels, obtaining a historical play corresponding to the first highest experience score, taking out multiple style labels of all other virtual objects in the historical play, and determining a style label with the highest frequency of occurrence among the multiple style labels as the first matching label corresponding to the respective style labels.

In a possible implementation of the first aspect, the determining second matching labels corresponding to respective style labels by using the experience scores of respective second type of historical plays of one or more first virtual objects belonging to respective style labels comprises:
obtaining a second highest experience score among the experience scores of the second type of historical plays of one or more first virtual objects belonging to respective style labels, obtaining a historical play corresponding to the second highest experience score, taking out multiple style labels of some of the virtual objects in the historical play, and determining a style label with the highest frequency of occurrence among the multiple style labels as the second matching label corresponding to the respective style labels.

In a possible implementation of the first aspect, in the first obtaining step, corresponding style labels are set for respective first virtual objects by using a clustering algorithm, wherein each style label is corresponding to at least one first virtual object.

In a possible implementation of the first aspect, the historical data in respective historical plays comprises feedback data in respective historical plays,
wherein, in the calculation step, the experience scores of respective historical plays are calculated based on the feedback data in respective historical plays by using a predetermined calculation function.

In a possible implementation of the first aspect, the method further includes: a strength adjustment step for interfering with, in the current play, the second virtual object in real time by using the first reinforcement learning model to adjust strength of the second virtual object.

In a possible implementation of the first aspect, the strength adjustment step further includes:
a second obtaining step for obtaining first real-time play data of the first virtual object closest to the second virtual object during the current play;
a second training step for inputting the first real-time play data into the first reinforcement learning model for training; and
an interfering step for interfering with an input and/or output of the second virtual object in real time by using an output of the first reinforcement learning model, to adjust strength of the second virtual object.

In a possible implementation of the first aspect, the method further includes: a label adjustment step for adjusting, in the current play, the style label in real time by using the second reinforcement learning model to obtain an updated style label, so as to change the second virtual object to an updated second virtual object corresponding to the updated style label.

In a possible implementation of the first aspect, the label adjustment step further includes:
a pre-training step for using the historical data of the first virtual object for training to obtain the second reinforcement learning model;
an action execution step for executing, in the current play, by the second virtual object, a current action corresponding to a current style label in the virtual environment, and generating one or more parameters in a current state;
a second training step for inputting the current action and one or more parameters in a previous state generated by executing a previous action into the second reinforcement learning model for training; and
an updating step for outputting, by the second reinforcement learning model, the updated style label, to change the second virtual object into an updated second virtual object corresponding to the updated style label.

According to a second aspect, an embodiment of the present disclosure provides a computer program product, comprising computer-executable instructions, wherein the instructions are executed by a processor to implement the method for controlling virtual objects in a virtual environment according to the first aspect.

According to a computer-readable storage medium having stored thereon instructions configured to, when executed on a computer, cause the computer to perform the method for controlling virtual objects in a virtual environment according to the first aspect.

According to a fourth aspect, an embodiment of the present disclosure provides an electronic device, including:
one or more processors;
one or more memories;
wherein, one or more programs are stored in the one or more memories, and when the one or more programs are executed by the one or more processors, the electronic device is caused to perform the method for controlling virtual objects in a virtual environment according to the first aspect above.

According to a fifth aspect, an embodiment of the present disclosure provides an apparatus for controlling virtual objects in a virtual environment, and the apparatus includes: a first obtaining unit configured to obtain historical data of multiple historical plays of one or more first virtual objects in the virtual environment, and set corresponding style labels for respective first virtual objects based on the historical data; a first training unit configured to use the historical data of one or more first virtual objects belonging to respective style labels for training, so as to obtain second virtual objects corresponding to respective style labels; a calculation unit configured to calculate, for respective historical plays of each first virtual object, experience scores of respective historical plays by using the historical data of respective historical plays; and a matching unit configured to determine matching labels corresponding to respective style labels by using the experience scores of respective historical plays of one or more first virtual objects belonging to respective style labels, and select one or more corresponding second virtual objects based on the matching labels to join a current play.

The first obtaining unit, the first training unit, the calculation unit, and the matching unit may be implemented by a processor in an electronic device having functions of these modules or units.

In the present disclosure, according to the historical data of the player, the player can be matched with an AI companion with a suitable style label, so that a problem that the current AI companion has a single style and cannot match players with different gameplays is solved. In the present disclosure, a first reinforcement learning model can interfere with an AI companion model according to a real-time skill level of a real player, so that a skill level of the AI companion model matches that of the real player. In addition, the interfering method of the present disclosure does not need to train and store multiple AI companion models of different skill levels, but only interferes with the strength of the AI companion models, and therefore the requirements for storage and calculation are reduced. Further, in the present disclosure, the style (strategy) of the AI companion model can be optimized in real time during the game process, to match the style (gameplay) of the player in real time, so that the anthropomorphism of the AI companion model is improved.

### BRIEF DESCRIPTION OF DRAWINGS

FIG. 1 is a block diagram of an electronic device according to some embodiments of the present disclosure;

FIG. 2 is a schematic flowchart of a method for controlling virtual objects in a virtual environment according to some embodiments of the present disclosure;

FIG. 3 is a strength adjustment step further included in a method for controlling virtual objects in a virtual environment according to some embodiments of the present disclosure;

FIG. 4 is a flowchart of the strength adjustment step in FIG. 3;

FIG. 5 is a label adjustment step further included in a method for controlling virtual objects in a virtual environment according to some embodiments of the present disclosure;

FIG. 6 is a flowchart of the label adjustment step in FIG. 5 according to some embodiments of the present disclosure; and

FIG. 7 is a structural diagram of an apparatus for controlling virtual objects in a virtual environment according to some embodiments of the present disclosure.

### DETAILED DESCRIPTION OF EMBODIMENTS

Illustrative embodiments of the present disclosure include, but are not limited to, a method for controlling virtual objects in a virtual environment, a medium, an electronic device, and a computer program product.

Embodiments of the present disclosure are further described in detail below with reference to the accompanying drawings.

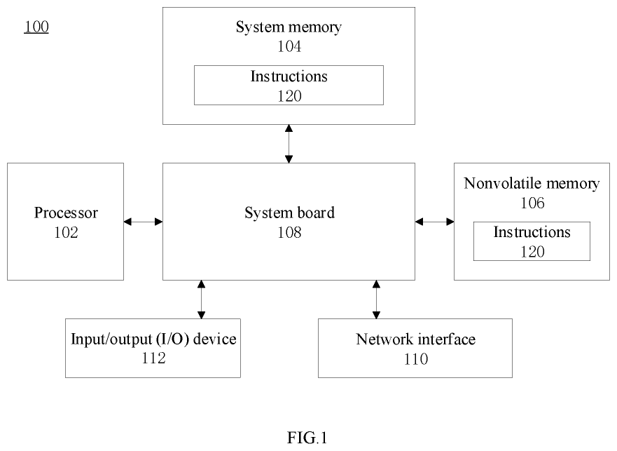

FIG. 1 is a block diagram of an electronic device according to some embodiments of the present disclosure.

As shown in FIG. 1, the electronic device 100 may include one or more processors 102, a system board 108 connected to at least one of the processors 102, a system memory 104 connected to the system board 108, a nonvolatile memory (NVM) 106 connected to the system board 108, and a network interface 110 connected to the system board 108.

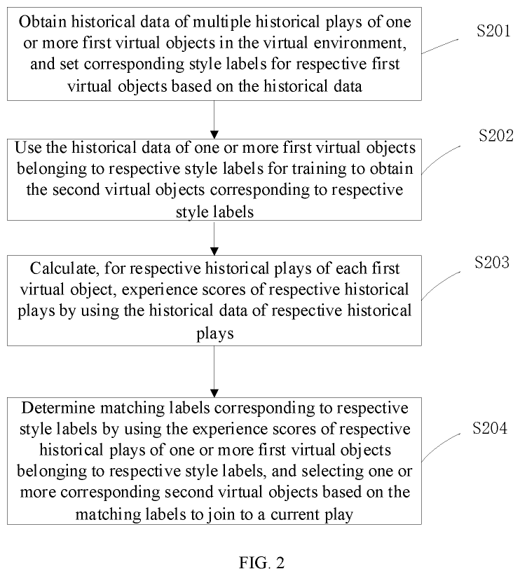

The processor 102 may include one or more single-core or multi-core processors. The processor 102 may include any combination of a general-purpose processor (CPU) and a special-purpose processor (such as, a graphics processing unit, an application processor, or a baseband processor). In the embodiments of the present disclosure, the processor 102 may be configured to perform one or more embodiments in various embodiments shown in FIG. 2.

In some embodiments, the system board 108 may include any suitable interface controller (not shown in FIG. 1), to provide any suitable interface for at least one of the processors 102 and/or any suitable device or component communicating with the system board 108.

In some embodiments, the system board 108 may include one or more memory controllers to provide an interface connected to the system memory 104. The system memory 104 may be used to load and store data and/or an instruction 120. In some embodiments, the system memory 104 of the electronic device 100 may include any suitable volatile memory, such as a suitable dynamic random access memory (DRAM).

The nonvolatile memory 106 may include one or more tangible and non-transitory computer-readable media for storing data and/or the instruction 120. In some embodiments, the nonvolatile memory 106 may include any suitable nonvolatile memory such as a flash memory and/or any suitable nonvolatile storage device, such as at least one of a HDD (Hard Disk Drive, hard disk drive), a CD (Compact Disc, Compact Disc) drive, and a DVD (Digital Versatile Disc, Digital Versatile Disc) drive.

The nonvolatile memory 106 may include a portion of storage resources installed on the apparatus of the electronic device 100, or may be accessed by an external device, but is not necessarily part of an external device. For example, the nonvolatile memory 106 may be accessed over a network via the network interface 110.

In particular, the system memory 104 and the nonvolatile memory 106 may respectively include: a temporary copy and a permanent copy of the instruction 120. The instruction 120 may include: an instruction that causes the electronic device 100 to implement the method shown in FIG. 2 when executed by at least one of the processors 102. In some embodiments, the instruction 120, hardware, firmware, and/or software components thereof may additionally/alternatively reside in the system board 108, the network interface 110, and/or the processor 102.

The network interface 110 may include a transceiver for providing a radio interface for the electronic device 100 to communicate with any other suitable devices (such as, a front-end module and an antenna) by using one or more networks. In some embodiments, the network interface 110 may be integrated with other components of the electronic device 100. For example, the network interface 110 may be integrated into at least one of the processor 102, the system memory 104, the nonvolatile memory 106, and a firmware device (not shown) having an instruction, and when at least one of the processors 102 executes the instruction, the electronic device 100 implements one or more embodiments in various embodiments shown in FIG. 2.

The network interface 110 may further include any suitable hardware and/or firmware to provide a multiple-input multiple-output wireless interface. For example, the network interface 110 may be a network adapter, a wireless network adapter, a telephone modem, and/or a wireless modem.

In one embodiment, at least one of the processors 102 may be packaged with one or more controllers used for the system board 108 to form a system in a package (SiP). In one embodiment, at least one of the processors 102 may be integrated on the same die with one or more controllers used for the system board 108 to form a system on a chip (SoC).

The electronic device 100 may further include: an input/output (I/O) device 112 connected to the system board 108. The I/O device 112 may include a user interface, so that a user can interact with the electronic device 100; peripheral components can also interact with the electronic device 100 by using a design of a peripheral component interface. In some embodiments, the electronic device 100 further includes a sensor for determining at least one of environmental conditions and location information related to the electronic device 100.

In some embodiments, the I/O device 112 may include, but is not limited to, a display (such as, a liquid crystal display and a touch screen display), a speaker, a microphone, one or more cameras (such as, a still image camera and/or a video camera), a flashlight (such as, a light-emitting diode flash), a keyboard, and a graphics card.

In some embodiments, the peripheral component interface may include, but is not limited to, a non-volatile memory port, an audio jack, and a power interface.

In some embodiments, the sensor may include, but is not limited to, a gyroscope sensor, an accelerometer, a proximity sensor, an ambient light sensor, and a positioning unit. The positioning unit may further be a part of or interact with the network interface 110 to communicate with components of a positioning network (for example, Global Positioning System (GPS) satellite).

It can be understood that, the structure illustrated in the embodiment of the present disclosure does not constitute a specific limitation on the electronic device 100. In other embodiments of the present disclosure, the electronic device 100 may include more or fewer components than those shown in the figure, or combine some components, or split some components, or have different component arrangements. The illustrated components may be implemented in hardware, software, or a combination of software and hardware.

Program code can be applied to input instructions to perform the functions described in the present disclosure and to generate output information. The output information may be applied to one or more output devices in a known manner. For purposes of the present disclosure, a system used for processing the instructions and including the processor 102 includes any system with a processor such as a digital signal processor (DSP), a microcontroller, an application specific integrated circuit (ASIC), or a microprocessor.

The program code can be implemented in a high-level programming language or an object-oriented programming language to communicate with a processing system. The program code can also be implemented in an assembly language or a machine language, if desired. In fact, the mechanism described in the present disclosure is not limited in scope to any particular programming language. In either case, the language may be an assembly language or an interpreted language.

One or more aspects of at least one embodiment can be implemented by instructions stored on a computer-readable storage medium, and when the instructions are read and executed by a processor, the electronic device can implement the method of the embodiment described in the present disclosure.

The method for controlling virtual objects in a virtual environment provided in the present disclosure may be applied to the electronic device 100 shown in FIG. 1. The electronic device 100 is, for example, a server 100.

As shown in FIG. 2, FIG. 2 is a flowchart of a method for controlling virtual objects in a virtual environment according to an embodiment of the present disclosure. The virtual objects include a first virtual object controlled by a user, and a second virtual object controlled by the artificial intelligence.

In the embodiment, the virtual environment is, for example, a game environment, the first virtual object is, for example, a virtual player (hereinafter also simply referred to as a player) in the game environment controlled by a user, and the second virtual object is, for example, an AI companion in the game environment.

In a first obtaining step S201, the processor 102 in the server 100 obtains historical data of multiple historical plays of one or more virtual players in the game environment, and sets corresponding style labels for respective virtual players based on the historical data.

The historical data may include player attribute data and player behavior data. The player attribute data includes: a recharge record for a game account, game points, total game time, a total number of game openings, historical modes of game openings (for example, a single player mode, a multiplayer teammate-mismatching mode, and a multiplayer teammate-matching mode, and etc.), and history standings etc. The player behavior data includes: average/highest total damage in a game, average/highest precision damage in a game, average/highest hits in a game, average/highest precision hits in a game, average/highest sustained damage in a game, average number of teammates healed/rescued in a game, and average/longest moving distance, etc.

Then, the historical data is used to set a label for each virtual player by using a clustering algorithm. In this embodiment, the clustering algorithm used is, for example, DBSCAN (Density-Based Spatial Clustering of Applications with Noise). DBSCAN is a well-known density clustering algorithm, which defines clusters as the largest collection of density-connected points, can divide areas with sufficient density into clusters, and can find clusters with arbitrary shapes in spatial data sets with noises. A radius of neighborhood Eps and the minimum number of points MinPts are predetermined by a k-nearest neighbor algorithm (a data set classification algorithm), and the minimum number of points MinPts refers to the minimum number of points that can form a cluster in a neighborhood. For example, when MinPts=4, if there are any four or more points in a neighborhood whose center is a point and whose radius is Eps, the point is marked as a core point.

Using DBSCAN algorithm: \textcircled{1}a spatial database is first established based on the historical data of all virtual players, and all virtual players are marked as unprocessed.
\textcircled{2} A virtual player is randomly selected, for example, the virtual player a is selected. The neighborhood NEps (a) of the virtual player a is checked. If the number of virtual players included in NEps (a) is less than MinPts, the virtual player a is marked as a noise point, switching to a next virtual player, and step\textcircled{2} is repeated. Otherwise, the virtual player a is marked as a core point, a new style label La is created, and the style label La is set for all virtual players in NEps (a). NEps (a) is used to represent a set of points (other virtual players) whose distance to the virtual player a is less than or equal to Eps.
\textcircled{3} For all the unmarked virtual players in NEps (a), their respective neighborhoods are checked respectively. If the number of virtual players included in the neighborhood of an unmarked virtual player is greater than MinPts, the style label La is set for all players without any label in the neighborhood, and the virtual player is marked as another core point. Otherwise, the virtual player is marked as a boundary point.

After the DBSCAN algorithm is used, for example, D style labels of all players can be obtained. It can be understood that multiple players can belong to the same style label.

In a first training step S202, it uses the historical data of multiple virtual players belonging to respective style labels for training to obtain AI companions corresponding to respective style labels.

Specifically, for example, D style labels are obtained as above, and each style label corresponds to at least one virtual player. For example, a style label L1 includes 40 virtual players, a style label L2 includes 100 virtual players . . . and a style label LD includes 150 virtual players. For the style label L1, the historical data of 40 virtual players (for example, battle data in each historical play) is used to train to obtain a corresponding AI companion, such as an AI companion 1. Similarly, for respective style labels, corresponding AI companions can be obtained by training in a similar manner, for example, an AI companion 2, an AI companion 3 . . . an AI companion D. It can be understood that each AI companion is an AI companion model.

Next, in a calculation step S203, for respective historical plays of each virtual player, the historical data of respective historical plays is used to calculate experience scores of respective historical plays.

Specifically, the historical data in respective historical plays includes feedback data in respective historical plays. The experience scores of respective historical plays are calculated based on the feedback data in respective historical plays by using a predetermined calculation function.

The feedback data includes, for example, speaking by the virtual player in each historical play, behavior of reporting/liking after the historical play ends.

Using following predetermined calculation function (1), it calculates the experience scores (experience) of respective historical plays of all virtual players by using the feedback data and standings of respective historical plays of all virtual players.

$$experience = a \cdot {\sum }_{i = 1}^{m} during + b \cdot after + c \cdot score \qquad ( 1 )$$

Where a, b, c are weights, and a+b+c=1 “during” is the emotional tendency of speaking each time during the historical play, 1=positive speaking, 0=no emotional tendency, −1=negative speaking, and m is the total number of times of speaking during the historical play. “after” is the behavior of reporting/liking after the historical play ends, 1=like, 0=misoperation, −1=report. “score” is a score (that is, standings) of a plyer in this historical play.

In a matching step S204, it determines matching labels corresponding to respective style labels by using the experience scores of respective historical plays of one or more first virtual objects belonging to respective style labels, and one or more corresponding second virtual objects are selected based on the matching labels to join to a current play.

Multiple historical plays include a first type of historical play and a second type of historical play. The current play includes the first type of current play and the second type of current play. Two types of historical plays and two types of current plays are explained below respectively.

For example, in a battle royale game, players who choose to start the game within a period of time are matched with a same current play, and when there are a total of N virtual objects in the current play, the current play is started. It is assumed that there are M players in the current play. If the total number of players is less than N before the current play starts, that is, M<N, AI companion(s) is required to be matched to join the current play. In order to improve game experience of the players, corresponding AI companion(s) is required to be selected according to style labels of the players in the current play. These players have a total of, for example, J types of labels (JSM), and (N−M) AI companions should be matched in the current play, and these AI companions have a total of, for example, K types of labels (K≤(N−M)).

There are different types of plays, such as a single-player ranking play mode and a multiplayer ranking play mode. The single-player ranking play mode indicates that, in this play, each virtual object treats all other virtual objects as enemies. The multiplayer ranking play mode indicates that, in this play, multiple virtual objects form multiple teams, and the teams fight against each other. The player can form a team with other players and choose to start the game, or teammates can be automatically matched for the player after the player chooses to start the game and before the current play starts. The automatically matched teammates can be other players or the AI companions. Therefore, the historical play includes a historical single-player ranking play and a historical multiplayer ranking play, and the current play includes a current single-player ranking play and a current multiplayer ranking play. When an AI companion is matched, the types of current play and historical play need to be considered.

For the current single-player ranking play, it determines first matching labels corresponding to respective style labels by using the experience scores of respective historical single-player ranking plays of one or more players belonging to respective style labels.

Specifically, a first highest experience score among the experience scores of the historical single-player ranking plays of one or more players belonging to respective style labels is obtained, and a historical single-layer ranking play corresponding to the first highest experience score is obtained. Multiple style labels of all other virtual objects (that is, all enemies) in the historical single-player ranking play are obtained, and a style label with the highest frequency of occurrence among the multiple style labels is determined as the first matching label corresponding to the style label.

For example, for all players belonging to a style label L1, a first highest experience score among all experience scores (experience) of all historical single-player ranking plays of these players is obtained, and a historical single-player ranking play corresponding to the first highest experience score is obtained, such as a game G. Multiple style labels of all other virtual objects (that is, all enemies, including all other players and all AI companions) in the game G are obtained, and a style label with the highest frequency of occurrence (such as L2) among the multiple style labels is used as the first matching label L2 corresponding to the style label L1. Alternatively, multiple style labels of all other players in the game G are obtained, and a style label with the highest frequency of occurrence (such as L3) among the multiple style labels is used as the first matching label L3 corresponding to the style label L1.

In this way, in the current single-player ranking play, for respective style labels L of the players, respective first matching labels can be determined respectively.

In addition, for the current multiplayer ranking play, the experience scores of respective historical multiplayer ranking plays of one or more players belonging to respective style labels are used to determine second matching labels corresponding to respective style labels.

Specifically, a second highest experience score among the multiple experience scores of the multiple historical multiplayer ranking plays of one or more players belonging to respective style labels is obtained, and a historical multiplayer ranking play corresponding to the second highest experience score is obtained. Multiple style labels of some of the virtual objects (that is, teammates) in the historical multiplayer ranking play are taken out, and a style label with the highest frequency of occurrence among the multiple style labels is determined as the second matching label corresponding to the respective style labels.

For example, for one or more players belonging to a style label L4, if there are historical multiplayer ranking plays in the historical plays of these players and there is automatic teammate matching in the historical multiplayer ranking plays, a second highest experience score among all experience scores of all the historical multiplayer ranking plays of these players is obtained, and a historical multiplayer ranking play corresponding to the second highest experience score is obtained, for example, a game H. Multiple style labels of other teammates (that is, all other virtual objects in the team, including players and AI companions) in the game H are obtained, and a style label with the highest frequency of occurrence (such as L5) among the multiple style labels is determined as the second matching label L5 that matches the style label L4. Alternatively, multiple style labels of other teammate players in the game H are obtained, and a style label with the highest frequency of occurrence (such as L6) among the multiple style labels is used as the second matching label L6 corresponding to the style label L4.

In addition, if the historical plays of these players do not have historical multiplayer ranking plays or there is no automatic teammate matching in the historical multiplayer ranking plays, the second matching label is determined in a manner consistent with the current single-player ranking play.

In this way, in the current multiplayer ranking play, for respective style labels L of the players, respective second matching labels can be determined respectively.

As described above, for different types of current plays (that is, a current single-player ranking play or a current multiplayer ranking play), experience scores for different types of historical plays (that is, historical single-player ranking plays or historical multiplayer ranking plays) can be used to respectively determine corresponding first matching labels or second matching labels for players with different style labels, and corresponding AI companions are selected based on the first matching labels or the second matching labels to join the current play.

In the current single-player ranking play, each AI companion regards all other players as enemies, and therefore a single AI companion is used as a basic unit for matching. In this case, a goal of style matching of the AI companion is to provide an AI companion that makes the player have the best game experience. Therefore, it is desired that the selected AI companion enable those players with, for example, J types of labels in the current single-player ranking play to have the best game experience. A specific process of matching the AI companion in the current single-player ranking play is as follows:

For example, N virtual objects are required in the current single-player ranking play, and it is assumed that there are M players in the current single-player ranking play, and M<N.
1) Style Labels of all M Players are Obtained in the Current Play:

For each player, a distance from the player to all core points in the DBSCAN algorithm can be calculated according to the historical data of the player, and a style label corresponding to a core point closest to the player can be used as the style label of the player. In this way, for example, J types of style labels (JSM) can be obtained.

It can be understood that, when the player is a new player and has no historical data, a style label can be randomly assigned for the new player when a first play is performed. When the new player finishes the first play, the historical data exists, and therefore a style label can be determined for the new player in subsequent plays based on the historical data.
2) The number num_ai of required AI companions is obtained. For example, num_ai=N−M.
3) J first matching labels respectively corresponding to the J style labels of the M players are obtained.
4) The J first matching labels are sorted according to their respective frequency of occurrences.
5) Top P first matching labels are taken from the sorted J first matching labels (P<J), and num_ai AI companions are selected based on the P first matching labels to join the current single-player ranking play. It can be understood that, num_{Li} corresponding AI companions are selected based on each of the P first matching labels to join the current single-player ranking play, and num_{Li} meets

$$num\_ai = {\sum }_{i = 1}^{P} {num}_{Li} .$$

For example, three AI companions corresponding to the first matching label L1 among the P first matching labels are selected to join the current single-player ranking play, and six AI companions corresponding to another first matching label L5 among the P first matching labels are selected to join the current single-player ranking play.

In the current multiplayer ranking play, a team (that is, a two-person team/four-person team) is used as a basic unit to select the AI companions, and there are two cases as follows:

### 1) There are Players in the Team.

It is assumed that the number of teammates is num_team (num_team=2 or num_team=4), the number of players in the team is num_real (num_real<num_team), and the number of style labels of these players is num_real_label (num_real_label<num_real). In this case, a goal of style matching of the AI companion is to improve the game experience of the players in the team. Therefore, it is desired that (num_team-num_real) AI companions are selected, so that these players with num_real_label style labels in this game have the best game experience.

For the player in each team, a specific process of matching an AI companion is as follows:
1. The style labels of all players in the team that need to be matched with teammates are obtained. The method of obtaining the style labels is the same as the method of obtaining the style labels of all players in the current single-player ranking play. In this way, for example, num_real_label style labels can be obtained.
2. The number num_ai of required AI companions are obtained, for example, num_ai=num_team-num_real.
3. num_real_label second matching labels respectively corresponding to the num_real_label style labels are obtained.
4. The num real_label second matching labels are sorted according to their respective frequency of occurrences.
5. Top num_ai second matching labels among the sorted num_real_label second matching labels are selected, and corresponding AI companions are selected based on each of the num_ai second matching labels.

In this way, corresponding AI companion(s) can be selected for the player(s) in each team.

### 2) There are Only AI Companions in the Team.

For example, J style labels of all players in the current multiplayer ranking play are obtained according to the method in “1) there are players in the team”, and J second matching labels respectively corresponding to the J style labels are obtained. The J second matching labels are sorted according to their respective frequency of occurrences, top K second matching labels are taken, and num_{Li} corresponding AI companions are selected based on the K second matching labels, num_{Li} meets

$$num\_team = {\sum }_{i = 1}^{K} {num}_{Li} ,$$

where num_team is the number of teammates in the team.

It can be understood that, in the present disclosure, an AI companion that matches (corresponds to) the style label of the player can be selected according to the historical data of the player, so that a current problem that the AI companion has a single style and cannot match the players with different styles.

Because the data set for training the AI companion comes from a large number of players, and skill levels of the players may be high or low, the strength of the trained AI companion should be the average level of the players. However, because a game state obtained by the AI companion is more accurate than that of the player, and the reaction is faster than that of the player, the performance of the AI companion is generally higher than that of ordinary player. Therefore, the strength of the AI companion needs to be adjusted to adapt to the skill level of the player in real time.

Preferably, after an AI companion with a suitable style is matched for the player, the strength of the AI companion can further be adjusted in real time.

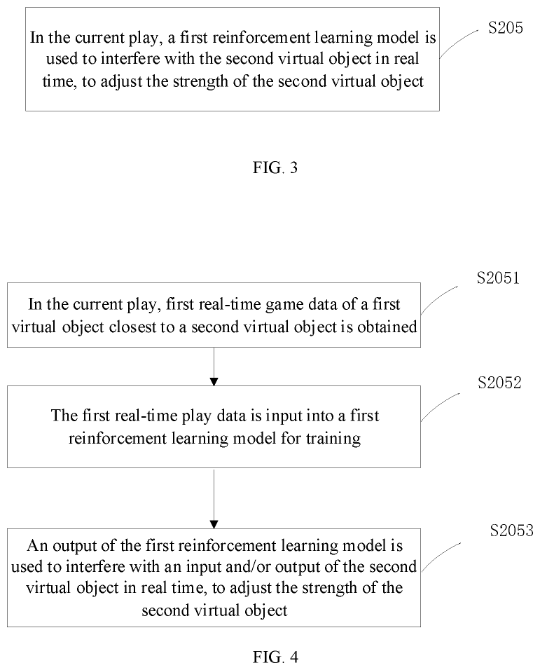

Referring to FIG. 3, the present disclosure further includes a strength adjustment step S205. In the current play, a first reinforcement learning model is used to interfere with the AI companion in real time, so as to adjust the strength of the AI companion. The first reinforcement learning model is, for example, a neural network model, and the neural network model is, for example, a fully connected neural network, a recurrent neural network, and etc.

FIG. 4 is a flowchart of the strength adjustment step S205. Referring to FIG. 4, in a second obtaining step S2051, in the current play, first real-time game data of a player closest to an AI companion whose strength needs to be adjusted is obtained.

The first real-time play data is, for example, real-time time-average play data of a player closest to the AI companion, and the real-time time-average play data is obtained as follows:
1) Cumulative data of the player in the current play is obtained: such as a total damage, a precision damage, the hits, the precision hits, sustained damage, number of teammates healed/rescued, and a moving distance;
2) Time-averaging is performed for the cumulative data in the current play. That is, the cumulative data in the current play is divided by the duration of the play, so as to obtain the real-time time-averaged play data of the player.

In a second training step S2052, the first real-time play data is input into the first reinforcement learning model for training. It can be understood that the above real-time time-averaged play data is input into the first reinforcement learning model for training.

In an interfering step S2053, an output of the first reinforcement learning model is used to interfere with the input and/or output of the AI companion (that is, the AI companion model) in real time, to adjust the strength of the AI companion.

It can be understood that, the output of the first reinforcement learning model can be used to interfere with the input of the AI companion. For example, a range of a viewing angle of the AI companion is reduced, and it is delayed to input observation results to the AI companion.

In addition, the output of the first reinforcement learning model can also be used to interfere with the output of the AI companion. For example, a hit rate of the AI companion is reduced, and certain operations of the AI companion (for example, movement is prohibited when shooting) are prohibited.

It can be understood that, the output of the first reinforcement learning model can be used to interfere with the input, output or both of the AI companion.

It can be understood that the output of the first reinforcement learning model is interfering manners for the AI companion. An example of the output of the first reinforcement learning model is shown in Table 1. Only four interfering manners are exemplified in Table 1, “1” indicates that the interfering is performed, and “0” indicates that the interfering is not performed. As shown in Table 1, the output of the first reinforcement learning model is [1, 0, 0, 1].

TABLE 1

| | | | Reduce the range | Delay the |
|---|---|---|---|---|
| | | Prohibit | of the viewing | observation |
| Interfering | Prohibit | aiming | angle of the AI | results of the AI |
| manner | movement | down sights | companion | companion |
| Whether to | 1 | 0 | 0 | 1 |
| perform | | | | |

It can be understood that the principle of reinforcement learning is to cause an intelligent agent continuously to interact with the game environment to obtain a reward, so as to guide the behavior of the intelligent agent, and its goal is to enable the intelligent agent to obtain the maximum reward. In this embodiment, the intelligent agent is the first reinforcement learning model which interferes with the strength of the AI companion model by different interfering manners. The goal is to make the strength of the AI companion model match the strength of the player. Therefore the reward can be set as the change amount of the real-time time-averaged play data of the player after the strength of the AI companion model is adjusted by using the first strength adjustment model. The method for obtaining the change amount of the real-time time-averaged play data of the player is as follows:
1) It records the last strength adjustment time tₙ₋₁ and the real-time time-averaged play data of the player at the time tₙ₋₁.
2) It records the current strength adjustment time tₙ and the real-time time-averaged play data of the player at the time tₙ.
3) A difference between the two recorded data is divided by (tₙ−(tₙ₋₁)) as a reward.

In the present disclosure, the first reinforcement learning model can interfer with the AI companion model according to the real-time skill level of the player, so that the skill level of the AI companion model matches the skill level of the player, and the difficulty of the game always matches the skill level of the layer. In addition, the strength adjustment method of the present disclosure only interferes with the strength of the AI companion model without training and storing multiple AI companion models of different skill levels, and therefore the requirements for storage and calculation are reduced.

In the current play, for example, as described in the matching step S204, an AI companion that matches the current style label of the player may be determined. It can be understood that a style of AI companion is corresponding to a strategy (a game strategy, also known as a gameplay). However, during playing, the strategy may need to be changed in real time. For example, when a blue circle shrinks, if the AI companion is at the edge of the blue circle and finds an enemy outside the blue circle, the player tends to run to a safe area, and then finds a cover to hide and makes a sneak attack on other players running to the safe area, while the AI companion looks for the enemies. Therefore, it is desirable that the style of the AI companion matches the gameplay (that is, the style) of the player in real time.

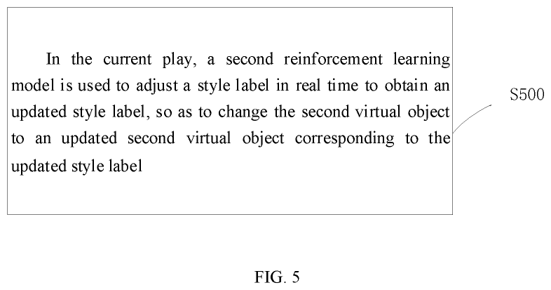

Preferably, the present disclosure further includes a label adjustment step S500 as shown in FIG. 5. In the current play, a second reinforcement learning model is used to adjust the style label in real time to obtain an updated style label, so as to change the AI companion to an updated AI companion corresponding to the updated style label.

It can be understood that the label adjustment step S500 can be performed after the matching step S204 or the strength adjustment step S205.

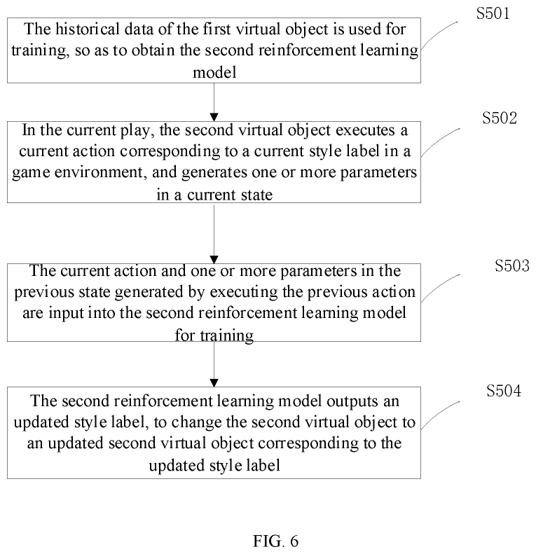

FIG. 6 shows a flowchart of the label adjustment step S500. Referring to FIG. 6, in a pre-training step S501, the historical data of the player is used for training, so as to obtain the second reinforcement learning model. The second reinforcement learning model is, for example, a neural network model, and the neural network model is, for example, a fully connected neural network and a recurrent neural network.

Specifically, historical time series data of players belonging to respective style labels in the historical play is obtained, and the historical time series data is, for example, a real-time state value, a real-time player style label, and a real-time reward value in the historical play.

The real-time state value is, for example, game time from opening, a real-time range of the blue circle, a real-time number of remaining virtual objects, a real-time amount of cumulative damage, and a real-time amount of cumulative healing, etc. For example, the real-time state value includes, for example, a state value at t1 and a state value at t2 etc. It can be understood that the state value at t1 is the game time from opening at t1, the range of the blue circle at t1, the number of remaining virtual objects at t1, the amount of cumulative damage at t1, and the amount of cumulative healing at t1, etc.

The method for obtaining the real-time player style label is similar to that described in the first obtaining step S201. That is, the historical time series data of the historical play of the player is first obtained, and the historical time series data is, for example, a real-time amount of cumulative total damage, a real-time amount of cumulative precision damage, real-time cumulative hits, the real-time cumulative precision hits, a real-time amount of cumulative sustained damage, real-time cumulative number of teammates healed/rescued, and a real-time cumulative moving distance in the historical play. Then, a corresponding style label is set (constructed) for the player by using a clustering algorithm, such as the DBSCAN algorithm.

The real-time player style label includes, for example, a player style label at t1 and a player style label at t2. It can be understood that the player style label at t1 is based on the amount of cumulative total damage, the amount of cumulative precision damage, the cumulative hits, the cumulative precision hits, the amount of cumulative sustained damage, the cumulative number of teammates healed/rescued, and the cumulative moving distance at t1. The player style label at t1 is set for the player by using a clustering algorithm, such as the DBSCAN algorithm.

The real-time reward value is the real-time emotional tendency, the real-time amount of damage, the real-time amount of healing, etc. when the player speaks in the historical play. Likewise, it can be understood that the real-time reward value includes a reward value at t1 and a reward value at t2, etc. The reward value at t1 includes, for example, the emotional tendency, the amount of damage, and the amount of healing at t1 when the player speaks.

For players belonging to each style label, the above real-time state value is used as an input, the real-time player style label is used as an output, and the real-time reward value is used as a reward, to construct and pre-train the neural network model, so that a pre-trained second reinforcement learning model for each style label is obtained.

In an action execution step S502, in the current play, the AI companion model executes a current action corresponding to a current style label in the game environment, and generates one or more parameters in a current state.

Before the current play is started, for example, as described in the matching step S204, a corresponding AI companion is selected based on the matching label to join the current play. In this case, the matching label is used as a current style label of the AI companion corresponding to the matching label. In this case, the AI companion is corresponding to an initial strategy. It can be understood that the initial strategy is a game strategy corresponding to the current style label.

The AI companion uses the initial strategy to execute an action in the game environment (for example, at time t1), and generates one or more parameters in the current state. The parameters are, for example, one or more state values generated in the game environment at time t1, and these state values are, for example, the game time from opening, the range of the blue circle, the number of remaining virtual objects, the amount of cumulative damage, and the amount of cumulative healing, etc.

In a second training step S503, the current action and one or more parameters in the previous state generated by executing the previous action are input into the second reinforcement learning model for training.

For example, the action executed at time t2 (that is, the current action) and one or more state values in the previous state generated by executing the action at time t1 (that is, the previous action) are input into the second reinforcement learning model as training samples, and the second reinforcement learning model is trained for maximizing the reward value of the second reinforcement learning model.

In an updating step S504, the second reinforcement learning model outputs an updated style label (that is, an updated strategy) after training, to change the AI companion to an updated AI companion corresponding to the updated style label.

It can be understood that at a next time (for example, at time t3), the updated AI companion generates an updated action according to the update strategy, returns to the action execution step S502 to execute the updated action, generates one or more state values at t3, and then performs the second training step S503 and the updating step S504. It can be understood that the action execution step S502, the second training step S503 and the updating step S504 are repeated to adjust (change) the AI companion in real time.

It can be understood that the output of the second reinforcement learning model is a style label (strategy) of the AI companion, and each style label is corresponding to an AI companion model, that is, each style label is corresponding to a strategy, and the AI companion model under different strategies executes different actions. In this way, during the game process, the second reinforcement learning model can update the AI companion model in real time.

It can be understood that the basis for generating actions by the AI companion model is the updated style label output by the second reinforcement learning model. It can be understood that during the game process, the AI model companion is constantly changed (adjusted). For example, the AI companion model corresponding to the A-style label is used within 0-5 minutes of the game, and the AI model corresponding to the B-style label is used within 5-10 minutes. It is controlled by the second reinforcement learning model which AI companion model is changed to and when the AI companion is changed.

It can be understood that the second reinforcement learning model can select the AI companion model corresponding to which style label. The second reinforcement learning model continuously learns during the game to update the model itself, so that the AI companion model output by the second reinforcement learning model is more in line with the current play process.

In the above adjustment process of the present disclosure, the second reinforcement learning model can be trained by using the actions and state values of the AI companion model in the game environment, so that the second reinforcement learning model can continuously output the updated style label, that is, the updated strategy, thereby continuously updating the AI companion model. Therefore, the style (strategy) of the AI companion model can be optimized in real time during the game process, so as to match the style (gameplay) of the player in real time, so that the anthropomorphism of the AI companion model is improved.

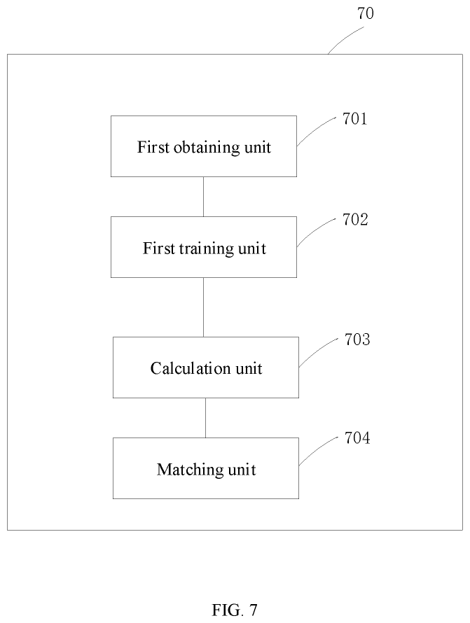

The present disclosure further provides an apparatus for controlling a virtual object in a virtual environment. FIG. 7 is a structural diagram of an apparatus 70 for controlling virtual objects in a virtual environment. As shown in FIG. 7, the apparatus 70 includes: a first obtaining unit 701 configured to obtain historical data of multiple historical plays of one or more first virtual objects in the virtual environment, and set corresponding style labels for respective first virtual objects based on the historical data; a first training unit 702, configured to use the historical data of one or more first virtual objects belonging to respective style labels for training, so as to obtain second virtual objects corresponding to respective style labels; a calculation unit 703 configured to calculate, for respective historical plays of each first virtual object, experience scores of respective historical plays by using the historical data of respective historical plays; and a matching unit 704 configured to determine matching labels corresponding to respective style labels by using the experience scores of respective historical plays of one or more first virtual objects belonging to respective style labels, and select one or more corresponding second virtual objects based on the matching labels to join a current play.

It can be understood that the first obtaining unit 701, the first training unit 702, the calculation unit 703, and the matching unit 704 may be implemented by the processor 102 having functions of these modules or units in the electronic device 100. The previously disclosed implementations are method implementations corresponding to this implementation, and this implementation can be implemented in cooperation with the above implementations. The relevant technical details mentioned in the foregoing implementations are still valid in this implementation. In order to reduce repetition, details are not described herein. Correspondingly, the relevant technical details mentioned in this implementation may also be applied in the foregoing implementation.

The present disclosure further provides a computer program product, including a computer-executable instruction, and the instruction is executed by the processor 102 to implement the method for training a virtual object in a virtual environment of the present disclosure. The previously disclosed implementations are method implementations corresponding to this implementation, and this implementation can be implemented in cooperation with the above implementations. The relevant technical details mentioned in the foregoing implementation manners are still valid in this implementation. In order to reduce repetition, details are not described herein. Correspondingly, the relevant technical details mentioned in this implementation may also be applied in the foregoing implementation.

The present disclosure further provides a computer-readable storage medium, on which an instruction is stored, and when the instruction is executed on a computer, the computer executes the method for training a virtual object in a virtual environment of the present disclosure. The previously disclosed implementations are method implementations corresponding to this implementation, and this implementation can be implemented in cooperation with the above implementations. The relevant technical details mentioned in the foregoing implementations are still valid in this implementation. In order to reduce repetition, details are not described herein. Correspondingly, the relevant technical details mentioned in this implementation may also be applied in the foregoing implementations.

It should be noted that in the examples and descriptions of this patent, relative terms such as first and second are only used to distinguish one entity or operation from another entity or operation, and do not necessarily require or imply there is no such actual relationship or sequence between these entities or operations. Moreover, the terms “include”, “comprise”, or their any other variant is intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the existence of additional identical elements in the process, method, article, or apparatus that includes the element.

Although the present disclosure has been shown and described with reference to certain preferred embodiments of the present disclosure, the person skilled in the art should understand that various changes in form and details may be made therein without departing from the spirit and scope of the present disclosure.

It should be noted that the sequence of the above embodiments of the present disclosure is only for description, and does not represent the advantageous and disadvantageous of the embodiments. The specific embodiments of this description are described above. Other implementations are within the scope of the appended claims. In some cases, the movements or steps recorded in the claims can be performed in a sequence different from that in the embodiments and still achieve desirable results. In addition, the processes depicted in the accompanying drawings do not necessarily require the particular order shown, or sequential order, to achieve desirable results. Multitasking and parallel processing are also possible or may be advantageous in certain embodiments.

It should be understood that in the above description of exemplary embodiments of the present disclosure, in order to streamline the present disclosure and to facilitate an understanding of one or more of the various inventive aspects, various features of the present disclosure are sometimes grouped together in a single embodiment, figure, or in its description. However, the method of this disclosure is not to be interpreted as reflecting an intention that the protected present disclosure requires more features than the features that are expressly recorded in each claim. Rather, as the claims reflect, inventive aspects lie in less than all features of a single foregoing disclosed embodiment. Therefore, the claims following a specific implementation are hereby expressly incorporated into this specific implementation, and each claim serves as a separate embodiment of the present disclosure.

The person skilled in the art can understand that the modules in the device in the embodiment can be adaptively changed and arranged in one or more devices different from the embodiment. Modules or units or components in the embodiments may be combined into one module or unit or component, and furthermore may be divided into a plurality of sub-modules or sub-units or sub-components. Except a fact that at least some of these features and/or processes or units are mutually exclusive, all disclosed features and all processes or units of any method or device that are disclosed in such a way in this specification (including the appended claims, the abstract, and the accompanying drawings) may be combined in any combination mode. Unless otherwise explicitly stated, each feature disclosed in this specification (including the appended claims, the abstract, and the accompanying drawings) may be replaced by an alternative feature that serves same, equivalent, or similar purposes.

Furthermore, those skilled in the art can understand that although some embodiments described herein include some features included in other embodiments but not other features, combinations of features from different embodiments are meant to be within the scope of the disclosure and form different embodiments. For example, in the claims, any one of the claimed embodiments can be used in any combination.

1. A method for controlling virtual objects in a virtual environment, used for an electronic device, the virtual objects comprising a first virtual object controlled by a user and a second virtual object controlled by artificial intelligence, wherein the method comprises:
a first obtaining step for obtaining historical data of multiple historical plays of one or more first virtual objects in the virtual environment, and setting corresponding style labels for respective first virtual objects based on the historical data;
a first training step for using the historical data of one or more first virtual objects belonging to respective style labels for training to obtain the second virtual objects corresponding to respective style labels;
a calculation step for calculating, for respective historical plays of each first virtual object, experience scores of respective historical plays by using the historical data of respective historical plays; and
a matching step for determining matching labels corresponding to respective style labels by using the experience scores of respective historical plays of one or more first virtual objects belonging to respective style labels, and selecting one or more corresponding second virtual objects based on the matching labels to join to a current play.

2. The method according to claim 1, wherein the multiple historical plays comprise a first type of historical play and a second type of historical play, and the current play comprises a first type of current play and a second type of current play,
wherein, in the matching step, determining first matching labels corresponding to respective style labels by using the experience scores of respective first type of historical plays of one or more first virtual objects belonging to respective style labels, and selecting one or more corresponding second virtual objects based on the first matching labels to join the first type of current play, and
determining second matching labels corresponding to respective style labels by using the experience scores of respective second type of historical plays of one or more first virtual objects belonging to respective style labels, and selecting one or more corresponding second virtual objects based on the second matching labels to join the second type of current play.

3. The method according to claim 2, wherein the determining first matching labels corresponding to respective style labels by using the experience scores of respective first type of historical plays of one or more first virtual objects belonging to respective style labels comprises:
obtaining a first highest experience score among the experience scores of the first type of historical plays of one or more first virtual objects belonging to respective style labels, obtaining a historical play corresponding to the first highest experience score, taking out multiple style labels of all other virtual objects in the historical play, and determining a style label with the highest frequency of occurrence among the multiple style labels as the first matching label corresponding to the respective style labels.

4. The method according to claim 2, wherein the determining second matching labels corresponding to respective style labels by using the experience scores of respective second type of historical plays of one or more first virtual objects belonging to respective style labels comprises:
obtaining a second highest experience score among the experience scores of the second type of historical plays of one or more first virtual objects belonging to respective style labels, obtaining a historical play corresponding to the second highest experience score, taking out multiple style labels of some of the virtual objects in the historical play, and determining a style label with the highest frequency of occurrence among the multiple style labels as the second matching label corresponding to the respective style labels.

5. The method according to claim 1, wherein, in the first obtaining step, corresponding style labels are set for respective first virtual objects by using a clustering algorithm, wherein each style label is corresponding to at least one first virtual object.

6. The method according to claim 1, wherein the historical data in respective historical plays comprises feedback data in respective historical plays,
wherein, in the calculation step, the experience scores of respective historical plays are calculated based on the feedback data in respective historical plays by using a predetermined calculation function.

7. The method according to claim 1, further comprising:
a strength adjustment step for interfering with, in the current play, the second virtual object in real time by using the first reinforcement learning model to adjust strength of the second virtual object.

8. The method according to claim 7, wherein the strength adjustment step further comprises:
a second obtaining step for obtaining first real-time play data of the first virtual object closest to the second virtual object during the current play;
a second training step for inputting the first real-time play data into the first reinforcement learning model for training; and
an interfering step for interfering with an input and/or output of the second virtual object in real time by using an output of the first reinforcement learning model, to adjust strength of the second virtual object.

9. The method according to claim 1, further comprising:
a label adjustment step for adjusting, in the current play, the style label in real time by using the second reinforcement learning model to obtain an updated style label, so as to change the second virtual object to an updated second virtual object corresponding to the updated style label.

10. The method according to claim 9, wherein the label adjustment step further comprises:
a pre-training step for using the historical data of the first virtual object for training to obtain the second reinforcement learning model;
an action execution step for executing, in the current play, by the second virtual object, a current action corresponding to a current style label in the virtual environment, and generating one or more parameters in a current state;
a second training step for inputting the current action and one or more parameters in a previous state generated by executing a previous action into the second reinforcement learning model for training; and
an updating step for outputting, by the second reinforcement learning model, the updated style label, to change the second virtual object into an updated second virtual object corresponding to the updated style label.

11. A computer program product, comprising computer-executable instructions, wherein the instructions are executed by a processor to implement the method for controlling virtual objects in a virtual environment according to claim 1.

12. A computer-readable storage medium having stored thereon instructions configured to, when executed on a computer, cause the computer to perform the method for controlling virtual objects in a virtual environment according to claim 1.

13. An electronic device, comprising:
one or more processors;
one or more memories;
wherein, one or more programs are stored in the one or more memories, and when the one or more programs are executed by the one or more processors, the electronic device is caused to perform the method for controlling virtual objects in a virtual environment according to claim 1.
